(19) United States
(12) Patent Application Publication
(10) Pub. No.: US 2005/0171931 A1
(43) Pub. Date: Aug. 4, 2005

(54) Database searching method and system

(75) Inventors: Gordon Smith Baxter, Cambridge (GB); Nick Tilford, Clavering (GB)

Correspondence Address: BLANK ROME LLP, THE WATERGATE BUILDING, 600 NEW HAMPSHIRE AVENUE, NW, WASHINGTON, DC, 20037, US

(73) Assignee: Biowisdom Limited, Cambridge (GB)

(21) Appl. No.: 10/509,106

(22) PCT Filed: Apr. 2, 2003
(86) PCT No.: PCT/GB03/01434

(30) Foreign Application Priority Data
Apr. 3, 2002 (GB) 0207749.3

(51) Int. Cl. G06F 17/30

(52) U.S. Cl. 707/3

(57) ABSTRACT

A method and system is described for searching a plurality of information databases (2,3,4) for records related to an input search term. The method comprises selecting a group of related search terms containing the input search term from a search database (7) of terms arranged in predefined groups according to their relationship with one another. Each term is present within one or more of the information databases (2,3,4). A data repository (5) is searched for terms from the selected group, the data repository comprising selected data previously extracted from the records of each information database (2,3,4). The search identifies the corresponding records within the information databases which contain the terms within the selected group.

The present invention relates to a method and system for searching a plurality of information databases.

Databases are well known and widely used for the organized storage of information. Depending upon the application in question, in many cases there is a great demand for the provision of searching methods to enable the stored information to be selectively accessed by a user. For this reason, a great deal of investment is often made in the production, updating and on-going development of such databases. The provision of improved searching methods forms part of this development.

In fields of particular scientific or commercial interest there often exist a number of databases providing related and/or overlapping information. These databases might result directly from different competing database suppliers or for example, due to the independent generation and cataloguing of scientific information.

One particular example of the use of numerous databases is in the field of biomedical science. The biomedical domain is a multi-disciplinary domain encompassing all areas of biology and medicine. There is a large and ever increasing volume of electronic biomedical information present upon a number of databases, which are individually dedicated to particular fields within the biomedical discipline.

Access to such information in cases such as these is unfortunately frustrated by the large number of disparate data sources and the lack of a standard nomenclature being used between them.

Although a multitude of nomenclature or classification systems exist, there is a lack of consistency relating to their architecture and content. This hinders the ease with which the databases can be accessed. The content can also be variable between such databases as expertly annotated versions tend to have narrow discipline-related perspectives, do not cover historical terms and indeed are not contemporaneous.

As a result, database users tend to focus their investigations upon single databases with which they are familiar. This has associated disadvantages in that information which is highly relevant to the user may be present upon one or more databases covering overlapping or related fields but this information will not become known to the user.

One of the main problems in such interrelated disciplines is that particular terms used in one discipline may not be identical to those used in a different discipline (a lack of semantic normalisation) and therefore automatic computer-based searching is severely limited. Furthermore, the arrangement of the information within such databases is generally unique to the database in question. The performance of a search upon multiple databases of this kind therefore often requires labourious searching on specific individual databases with a detailed knowledge of each subject being needed in order to perform a high quality search.

There is therefore a need to provide an improved searching method to enable searching across multiple databases.

In accordance with a first aspect of the present invention we provide a method of searching a plurality of information databases for records related to an input search term, comprising:—
selecting a group of related search terms containing the input search term, from a search database of terms arranged in predefined groups according to their relationship with one another, wherein each term is present within one or more of the information databases; and,
searching for terms from the selected group within a data repository comprising selected data previously extracted from the records of each information database, to identify the corresponding records within the information databases which contain the terms within the selected group.

The present invention overcomes many of the problems associated with searching a plurality of information databases, in that groups of related search terms are used to search upon the various databases provided. The semantic integration of information within multiple databases is very important to this process and the use of an ontology (or similar knowledge base) can provide the framework for this normalisation.

The terms are preferably made available through an ontology, knowledge base or thesaurus. These groups are predefined and, when an inputted search term is provided by a user, the search database is queried in order to select the one or more groups containing this inputted search term. In particular, this allows dissimilar terms having identical or similar meanings, to be searched upon the plurality of information databases. This greatly improves the power of the searching technique (for example, the precision and recall of a query) and directly allows extension of searching beyond a single database to multiple databases. The speed of multiple database searching is therefore improved as a result.

The method particularly benefits normal users who are familiar with only a single discipline, in that the provision of searching across multiple disciplines is provided without a detailed knowledge of these other disciplines being required.

The present invention is not limited to any particular types of information databases nor to the subject matter of their contents. However, the invention is particularly advantageous for use in cases where a number of large and complex information databases are provided, each providing related or overlapping information. This is notably the case in the biomedical field.

The present invention also recognises the problem that, for many databases, searching for information within more than one database may increase the amount of processor time required for searching. This is addressed by previously extracting selected data from the various information databases and storing it in a dedicated data repository. Only selected data is normally needed for search purposes, because with most types of search it is not necessary to search through all data contained within each record of the information databases. One example of this is in the searching of a biotechnology database in which lengthy gene sequences are provided but the searching of these actual sequences is not required. The presence of such sequences represents a large amount of redundant data insofar as a search is concerned which is related to the causes of disease.

It is therefore advantageous to extract data from the records of such information databases and to store the data separately in a data repository such that the speed and efficiency with which the data may be searched can be improved.

The data repository is preferably arranged as a number of records, with a repository record corresponding to a record present within one of the information databases. There is therefore preferably a direct correspondence between the number of individual records in the information databases and the number of individual records in the repository. Each record in the repository preferably further comprises a pointer identifying the specific record in the information database to which it relates. This is used to allow access by a user to the full record when required.

In the case of a direct correspondence of records between the repository and databases, this access may be achieved by simply using identical record identifiers (such as gene accession numbers). However in cases of non-direct correspondence, a specific and separate pointer to the particular record is used.

Due to the extraction of the data from the information databases, typically the amount of selected data in the repository is less than that contained in the information databases. The degree to which the former amount is smaller is dependent upon the particular type of record used and the fields which are desired to be searched within each record.

In general, the data in the repository comprises definitional and/or semantic data. The definitional data preferably describes data in terms of its nature, use or value whereas the semantic data preferably describes alternative terms for the data in the information databases. Generally, the semantic data describes synonymous terms in the information databases.

Within the search database, each term preferably has corresponding meta-data indicating the one or more information databases within which the particular term is contained. This information can be used to reduce needless searching upon databases where it is known that no such term is present. This therefore increases the search speed during use. Such meta-data also preferably indicates the one or more fields of the information database(s) within which it is contained as it will be recognised that each information database generally has a unique format.

Preferably the terms in the predefined groups are arranged within the search database such that the predefined groups are formed from synonymous terms. Each group is also typically provided with a unique group identifier.

Due to the possibility that an inputted search term may be found within more than one group, the method preferably further comprises determining the context of the records retrieved using the inputted search term (and associated group of terms). Following identifying the groups in which the term is present, when the repository is searched the context of each record may be determined during the search itself (to limit the number of records returned) or later following the selection of all records containing any terms in the group.

The context may be determined based upon the field type of the repository record in which the term is found such as a “domain”. Alternatively, or additionally, the context may be determined by searching for the presence of one or more of the other terms within the group, in the same field or record of the repository. This allows automatic selection of the correct search subject.

In general, the method according to the first aspect of the invention is performed by a computer program comprising suitable computer program code means. Such a computer program may be retained upon a computer readable medium.

In accordance with the second aspect of the present invention, we provide a database searching system for searching a plurality of information databases for records related to an inputted search term, the system comprising:—
a search database comprising related search terms arranged into predefined groups according to their relationship to one another, wherein each term is present within one or more of the information databases;
selection means, for selecting a group containing the inputted search term from the search database;
a data repository comprising selected data previously extracted from the records of each information database; and,
searching means for searching the repository for terms from the selected group to identify the corresponding records within the information databases which contain the terms within the selected group.

Typically therefore the search database and the searching system itself is based on an ontology.

Preferably the search term is provided to the system using an input means which may take the form of a local input device, or alternatively a communication network such as the Internet. The use of a communication network allows users to access the system from remote locations. The system may also comprise the information databases themselves, although typically these are also located remotely from the data repository. The selection and searching means are typically provided as a combined query system upon a computer. This computer may also contain either or both of the data repository and the search database.

An example of a multiple database search method and system according to the present invention will now be described, with reference to the accompanying drawings, in which:—

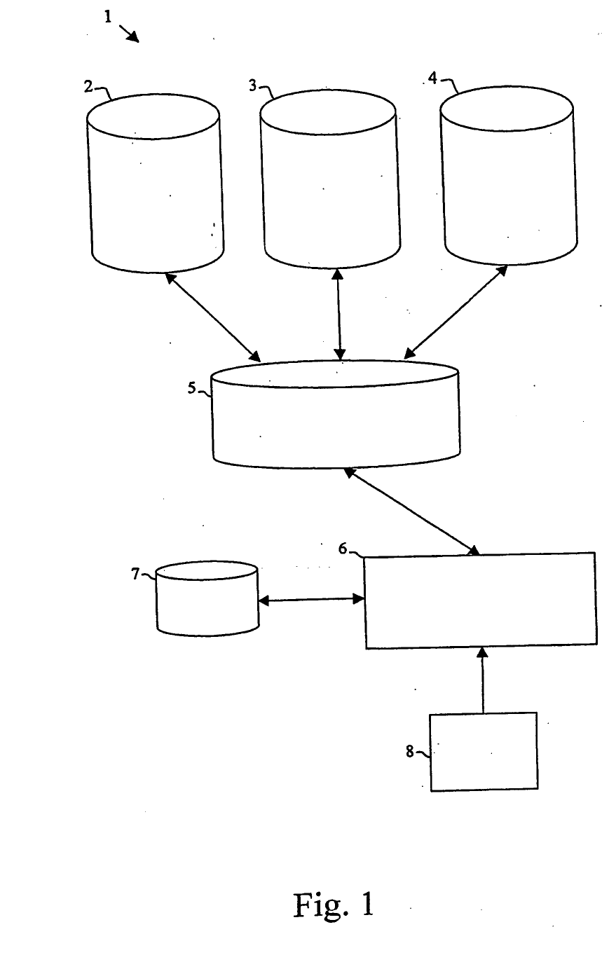

FIG. 1 is a schematic representation of the search system; and

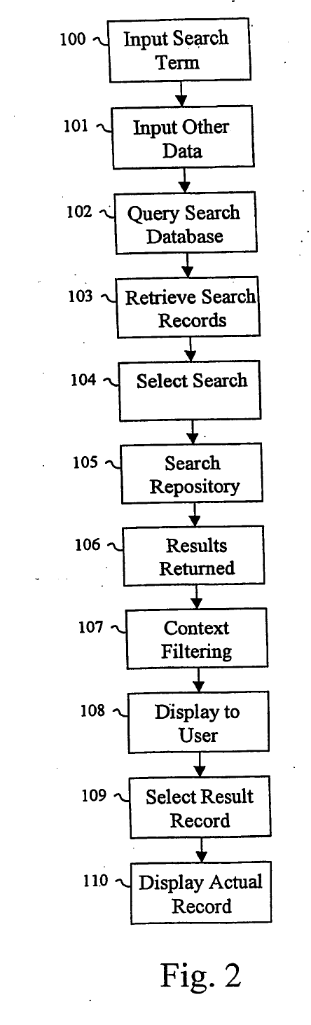

FIG. 2 is a flow diagram of a method of searching using the search system.

A multiple database system relating to the field of biomedical science is generally indicated at 1 in FIG. 1.

A number of individual proprietary information databases are indicated at 2, 3 and 4. Examples of these databases include “Genbank” (National Centre For Biotechnology Information), “Swissprot” (European Bioinformatics Institute), “OMIM” (National Centre For Biotechnology Information) and “UMLS” (National Library Of Medicine). In this example, three information databases are provided relating to gene sequences and genetic disorders.

A data repository 5 is arranged in communication with each of the information databases 2, 3, 4. The data repository 5 is organised as a database, stored on a local computer server. The information databases 2, 3, 4 are stored upon remote servers and accessed by the data repository 5 using a suitable network such as the Internet.

A query system 6 is arranged to access the data repository 5 and is implemented by suitable software running upon a local computer (which may be the server upon which the data repository 5 is stored).

A separate search database 7 (knowledge base or ontology) is also provided on the query system computer and this is arranged to be accessed by the query system 6. An input means 8 is provided to allow a user of the system to access the query system 6. In the present example, the input means 8 is a remote computer connected via a communication network such as the Internet, to the query system 6. Alternatively, it could be a local input device such as a keyboard attached to the query system computer.

Regarding the information databases 2, 3, 4, these are generally arranged as a large number of records, with each record corresponding to a particular entity. In the case of the Genbank database, the records are arranged according to individual gene sequences. Each record contains a large number of fields. Examples of these for the Genbank information database include: LOCUS, DEFINITION, ACCESSION, VERSION, KEYWORDS, SEGMENT, SOURCE, ORGANISM, REFERENCE, AUTHORS, TITLE, JOURNAL. A large amount of data is therefore provided in each record and not all of this is useful for searches of the type provided by the system of this example.

The data repository 5 provides a copy of each record within each of the information databases 2, 3, 4 and therefore mirrors the content of these databases. However, for each record, only data within selected fields is retained within the data repository 5 and therefore records within the data repository contain substantially less data than that provided within the full record upon the respective information databases. As to which fields are copied into the data repository 5, this is determined by the administrator of the system 1 and is dependent upon the type of searching services which are to be provided to a user.

Table 1 shows part of a record within the data repository 5 relating to the Genbank record for the HTR2B gene (AF156159).

TABLE 1

| | | Meta-Data | Meta-Data |
|---|---|---|---|
| Extracted Term | Genbank Field | Type | Field |
| HSHTR2B2 | LOCUS | definitional/ | SYNONYM |
| | | semantic | |
| DNA | LOCUS | definitional | DOMAIN |
| 21-APR-2000 | LOCUS | definitional | ENTRY DATE |
| HTR2B | DEFINITION | semantic | SYNONYM |
| Homo sapiens 5- | DEFINITION | definitional | DEFINTION |
| hydroxytryptamine | | | |
| 2B receptor | | | |
| (HTR2B) gene, | | | |
| exon 2. | | | |
| AF156159 | ACCESSION | definitional/ | SYNONYM |
| | | semantic | |
| Homo sapiens | ORGANISM | definitional | SPECIES |
| HTR2B | FEATURES/ | semantic | SYNONYM |
| | mRNA/gene | | |
| 5-hydroxytryptamine 2B | FEATURES/ | semantic | SYNONYM |
| receptor | mRNA/product | | |
| HTR2B | FEATURES/ | semantic | SYNONYM |
| | gene/gene | | |
| HTR2B | FEATURES/ | semantic | SYNONYM |
| | CDS/gene | | |
| 5-hydroxytryptamine 2B | FEATURES/ | semantic | SYNONYM |
| receptor | CDS/product | | |

In addition to the “Extracted term” data and the “Genbank field” data, extracted from Genbank and retained in the respective columns, the “Meta-Data Type” and “Meta-Data Field” columns of Table 1 provide additional information defining the type of data which is contained in the respective field. This is described as “meta-data” because data in these fields describe the data obtained from the information databases 2,3,4. Two types of meta-data are used in this example system, these being “definitional” and “semantic”.

Definitional meta-data is information that is used to uniquely describe and/or categorise data in terms of its nature, use, value and encumbrances. Semantic meta-data provides alternative terms for data such as synonyms or cross-references. Semantic meta-data is used to infer equality in meaning between data from the information databases 2,3,4. These two types of meta-data are not exclusive and therefore meta-data can be both descriptive and semantic. For example a gene name for a data record may be both definitional and semantic meta-data.

The “Meta-data type” column shows the kind of meta-data to which each extracted field relates and the “Meta-data Field” column defines a corresponding meta-data field for searching purposes. It can be seen in this latter case that a number of the fields from the information databases are assigned to the same meta-data field, namely “SYNONYM”.

In this particular record, the term “DNA” from this record is assigned to the “DOMAIN” meta-data field. The use of domains is described in more detail later.

Each record within the repository 5 also has associated meta-data in the form of a “pointer” which identifies the database and record from which the data was obtained. In this case, the Genbank field “ACCESSION” is used to identify the record and separate data (not shown in the Table 1) identifies the Genbank database.

Turning now to the search database 7, this is also arranged as a number of records, each record defining a group of synonymous terms. These terms are obtained from the information databases 2,3,4 and may relate to not only some synonymous terms within the same database but also synonymous terms between different information databases. Each record in search database 7, may also define broader and/or narrower related terms. Table 2 is an example of extracted synonyms from the Genbank record shown in Table 1.

TABLE 2

| Identifier | Synonym | Preferred Term |
|---|---|---|
| 012345678 | HSHTR2B2 | HTR2B |
| 012345678 | HTR2B | HTR2B |
| 012345678 | AF156159 | HTR2B |
| 012345678 | 5-hydroxytryptamine 2B | HTR2B |
| | receptor | |

Each synonym is assigned to a particular group identified with a corresponding group identifier which is internal to the system. Additionally, each group of synonyms has a “preferred” term which typically is the most commonly used or most convenient term for explanatory purposes. However, whether the actual preferred term is used as the inputted search term, does not affect the search scope.

Table 3 shows part of a typical record upon the search database 7, containing synonyms extracted from the three information databases 2, 3, 4, for example Genbank, Swissprot and OMIM. Any degeneracy between the terms extracted from these information databases is removed.

TABLE 3

| Identifier | Synonym | Preferred Term |
|---|---|---|
| 012345678 | HSHTR2B2 | HTR2B |
| | HTR2B | |
| | AF156159 | |
| | 5-hydroxytryptamine 2B | |
| | receptor | |
| | 5-HT2B | |
| | 5HT2B | |
| | Serotonin 2B receptor | |

Referring back to Table 1, it can be seen that each of the extracted terms which were assigned to the “SYNONYM” meta-data field, are also found within the same record in Table 3 (as the first four entries in the “Synonym” column). The use of the meta-data field increases the searching speed when a search for synonymous terms is being performed within the records of the data repository 5, as searching in other fields is not needed. It should be remembered that the data repository 5 contains records from a number of different information databases 2,3,4 and therefore assigning meta-data fields produces this speed increase.

Further information is also present within the records of the search database 7, for example, in the case of each synonym, an identifier is provided to identify the database(s) and in some cases the field(s) in which the term is present. Each of the search database records also contains a brief textual description of the subject to which the synonyms relate, such as “Gene that encodes the 5-hydroxpytryptamine 2B receptor”.

FIG. 2 shows a flow diagram of a suitable method for use in the database searching system 1. At step 100 in FIG. 2, a user of the system inputs a search term using the input means 8. At step 101, other information is also provided, for example in that the user selects a number of information databases upon which to search for the search term and possibly, a limitation to one or more field types in which to search for this term.

In the present example, each of the databases 2,3,4 is selected and the user chooses all field types for searching. At step 102, the query system 6 analyses the input search term and then searches upon the search database 7 for any records containing the input search terms. This returns one or more “hits”, that is records containing the search term as one of the synonymous terms. These records are then retrieved at step 103 and presented to the user.

In some cases, the search term will be present in more than one of the records upon the search database 7. In this case, the user can view the textual description attached to the record in order to select the type of information required.

Having reviewed the record description, at step 104, the user selects the particular record to which the intended search relates. At step 105, the synonymous terms held in the selected record of the search database 7 are then searched in the required fields of the records held in the data repository 5. Only those fields corresponding to the particular information databases selected by the user are searched and the results are then returned to the user at step 106.

At step 107 a context filtering step is performed which analyses the records in order to discard or categorise records which are unlikely to be related to the desired search. For example, in a case where more than one search database record is initially returned, there will exist at least one synonym (the search term) which is used upon the information databases in two different contexts. It is desirable to prevent the display of records which do not relate to the context of interest. This is achieved by context filtering.

The method chosen for this filtering depends upon the way in which the information databases are structured. In the case of more unstructured databases, for example databases of the full text of scientific publications, an appropriate filtering technique is to search for other words relating to the context of interest within the records (such as searching for the other synonyms). If none are found then the record in question can be assigned a low likelihood of relevance. If desired, this can be expressed mathematically for filtering and/or presented to the user.

For example, if a query has been performed on a term “C” and all its synonyms. The search database states that C is a sub-class of B and B is a sub-class of A. Also D and E are sub-classes of C. A series of queries are performed against the results set for C using synonyms of A, B, D and E sequentially. From the results of these queries, the records in the results set for term C can be scored for the co-occurrence of related-terms (A, B, D and E). These scores can determine how the results are presented to the end-user. This method can be extended to score for the proximity of the related term to the original search term.

For more structured information databases such as the biomedical science databases used in the present example, context filtering can be performed using the “domain” field as mentioned earlier. Upon construction of the data repository 5, the records are assigned to specific “domains” which represent broad topic classes such as DNA, disease, and so on. In this case, synonyms in a single search database record relate to information database records within a single domain. The search for records within the repository 5 can therefore be limited to records having the domain common to the synonyms within the group of interest. For example, if a database has fields relating to species and disease then a single record can be mapped, to the search database, by searching each field using synonyms from species and disease fields independently. A combination of these and other techniques can therefore be performed to effect context filtering. This filtering may be performed following retrieval of all of the records as in the present case, or it may be performed “on-the-fly”.

The retrieved and context filtered records from the data repository 5 are presented to the user at step 108. On selection of a particular record of interest by the user, at step 109 the pointer within the particular repository record of interest is accessed to discover the identity of the corresponding record upon one of the information databases 2,3,4. This full record is then retrieved from the specific information database and displayed to the user at step 110.

The above method can therefore advantageously be used to search for related information in databases which use different but synonymous terms to describe similar information. The selection of the extent to which terms are synonymous is at the discretion of the system administrator. Broader searches can be performed by using related rather than synonymous terms.

Although the amount of information searched is potentially in excess of that searched using a single database, the speed and efficiency of the searching is significantly increased by the use of the data repository in which selected record extracts are used for searching purposes.

In the present system, the user is not limited to searching using the technique described above as the method can be integrated with other conventional database searching tools which access the repository or the information databases directly.

1. A method of searching a plurality of information databases for records related to an input search term, comprising:
selecting a group of related search terms containing the input search term, from a search database of terms arranged in predefined groups according to their relationship with one another, wherein each term is present within one or more of the information databases; and,
searching for terms from the selected group within a data repository comprising selected data previously extracted from the records of each information database, to identify the corresponding records within the information 15 databases which contain the terms within the selected group.

2. A method according to claim 1, wherein the data repository is arranged as a number of records, each record corresponding to a record present within one of the 20 information databases.

3. A method according to claim 2, wherein each record in the repository comprises a pointer identifying the record in the information database to which it relates.

4. A method according to any of the preceding claim 1, wherein the amount of selected data in the repository is less than that contained in the information databases.

5. A method according to claim 4, wherein the data in the repository comprises definitional data.

6. A method according to claim 5, wherein the definitional data describe data in terms of its nature, use or value.

7. A method according to claim 4, wherein the data in the repository comprises semantic data.

8. A method according to claim 7, wherein the semantic data describes alternative terms for the data in the information database.

9. A method according to claim 8, wherein the semantic data describe synonymous terms in the information databases.

10. A method according to claim 4, wherein each term in each predefined group within the search database has associated meta-data indicating the one or more information databases within which the term is contained.

11. A method according to claim 10, wherein the corresponding meta-data indicates the one or more fields of the information database(s) within which it is contained.

12. A method according to claim 1, wherein a number of records within the data repository are assigned to a domain.

13. A method according to claim 4, wherein the terms in the predefined groups within the search database are synonymous terms.

14. A method according to claim 1, wherein each group has an associated group identifier.

15. A method according to claim 13, wherein each group has associated descriptive data for describing the group.

16. A method according to claim 12, further comprising determining the context of any repository records located.

17. A method according to claim 16, wherein the context is determined by limiting the search to repository records having a common domain.

18. A method according to claim 16, wherein the context is determined by searching for the presence of one or more of the other terms within the group, in the same record of the 30 repository.

19. A method according to claim 16, wherein the context is determined by searching in related classes of terms.

20. A method according to claim 16, wherein the context is determined by the proximity of one or more related terms within a record.

21. A computer program product comprising; a computer readable medium; and computer program code means on the compuer readable medium adapted to perform the method according to claim 1.

22. (canceled)

23. A database searching system for searching a plurality of information databases for records related to an inputted search term, the system comprising:
a search database comprising related search terms arranged into predefined groups according to their relationship to one another, wherein each term is present within one or more of the information databases;
selection means, for selecting a group containing the inputted search term from the search database;
a data repository comprising selected data previously extracted from the records of each information database; and,
searching means for searching the repository for terms from the selected group to identify the corresponding records within the information databases which contain the terms within the selected group.

24. A system according to claim 23, wherein further comprising an input means for supplying the inputted search term to the selection means.

25. A system according to claim 24, wherein the input means comprises a communication network such that the inputted search term is received from a remote location.

26. A system according to claim 23, further comprising a plurality of information databases from which data is extracted for storage within the data repository.

27. A system according to claim 23, wherein the data repository, is stored upon a separate computer system with respect to the information databases.

28. A method according to claim 14, wherein each group has associated descriptive data for describing the group.
